(19) United States
(12) Patent Application Publication
(10) Pub. No.: US 2007/0002386 A1
(43) Pub. Date: Jan. 4, 2007

(54) Image capturing apparatus, control method thereof, program, and storage medium

(76) Inventor: Ryunosuke Iijima, Ebina-shi (JP)

Correspondence Address: MORGAN & FINNEGAN, L.L.P., 3 WORLD FINANCIAL CENTER, NEW YORK, NY, 10281-2101, US

(21) Appl. No.: 11/478,384

(22) Filed: Jun. 28, 2006

(30) Foreign Application Priority Data
Jun. 29, 2005 (JP) 2005-190504

(51) Int. Cl. G06F 3/12

(52) U.S. Cl. 358/296; 358/1.15

(57) ABSTRACT

The present invention improves the convenience of a still image check operation after recording when a still image is recorded by using a self-timer or remote controller. An image capturing apparatus capable of recording a still image by using a self-timer includes an image capturing device configured to capture an image of an object, a display panel configured to display a still image captured by the image capturing device, an operation key configured to operate the image capturing apparatus, a control unit configured to control the display panel to display a recorded still image on the display panel after still image recording using the self-timer is performed, and to continue to display the recorded still image on the display panel until the operation key is operated.

### FIELD OF THE INVENTION

The present invention relates to a control technique for image display after still image recording by a self-timer and remote controller.

### BACKGROUND OF THE INVENTION

Conventionally, in still image recording using a self-timer, a still image is recorded a predetermined time after the release, the recorded still image is displayed for review for a given time, and then the display returns to a normal preview window. That is, a still image recording operation is the same as in recording by pressing a release button of a digital camera main body, except that time delay of recording is generated for the release button of the digital camera main body.

Japanese Patent No. 3501035 discloses a technique of selecting time delay of still image recording from a self-timer setting item and changing a review display time of a recorded still image after still image recording in correspondence with the delay time.

In still image recording using a remote controller, a still image recording operation is the same as an operation of merely pressing a release button mounted on a digital camera main body except that still image recording can be performed from a remote location.

A conventional operation of a digital video camera which can photograph a still image will be described below.

FIG. 1 is a block diagram showing the arrangement of a digital video camera 100 which can photograph a still image.

In FIG. 1, reference numeral 1 denotes a focus lens for adjusting the focus. Light passed through the focus lens 1 is adjusted to an appropriate light amount by a diaphragm 2 controlled by a system controller 14. The light passed through the diaphragm 2 forms an image on an image sensing plane of a CCD 3 as an image sensor and is photo-electrically converted into an electric signal. The photo-electrically converted signal is read out by a reference clock generated by a TG (Timing Generator) 6, and is sampled and held by a CDS/AGC circuit 4 and controlled to an appropriate gain at the same time. An A/D converter 5 converts an output signal from the CDS/AGC circuit 4 into a digital signal synchronized with the reference clock. An image signal converted into a digital signal undergoes various signal processing in a camera signal processing circuit 7 to generate image data. Frame memory 8 is used for temporarily holding image data generated in the camera signal processing circuit 7. A liquid crystal driver 9 converts image data having undergone image processing in the camera signal processing circuit 7 into a signal to be displayed on a liquid crystal panel 10, and displays a sensed image on the liquid crystal panel 10. A recorder recording/playback unit 11 is used to digitally record or play back moving image data having undergone digital signal processing on a tape. A compression circuit 12 compresses a still image and moving image by a compression ratio designated by the system controller 14. Compressed image data is recorded in a memory card 13. A self-timer setting key 15 is an input means for setting a self-timer in the system controller 14. A still image recording switch 16 is a release switch for still image recording. A remote control light-receiving element 17 is a device for receiving an infrared light control signal from a remote controller.

FIG. 4 is a flowchart showing the operation of the conventional system controller 14 when a self-timer is used.

The flow starts from step S200 and advances to step S201 to determine if a still image recording mode is set. If NO in step S201, the flow advances to step S217 to terminate the process without performing any processing.

If YES in step S201, the flow advances to processing in step S202 to determine if a self-timer setting is ON. If the self-timer setting is ON, the flow advances to step S203. If the self-timer setting is OFF, the flow advances to step S211.

In step S203, it is determined if a release operation is executed. If a release operation is not executed, the flow advances to step S217 to terminate the process. If a release operation is executed, the flow advances to step S204 to start a self-timer measurement counter.

Next, the flow advances to step S205 to determine if a predetermined time of the self-timer measurement has elapsed. If a predetermined time has elapsed in step S205, the flow advances to step S206 to perform still image recording.

The flow advances to step S207 to hold a still image review display and advances to step S208 to measure a still image review holding time for the self-timer. If a predetermined time has elapsed in step S208, the flow advances to step S209 to cancel the still image review display (operation to display a recorded still image immediately after recording). The flow advances to step S210 to display a still image preview image (operation to display the angle of view for still image recording in motion upon recording a still image) and then advances to step S217 to terminate the process.

The sequence of conventional still image recording using a self-timer is described above. Next, the sequence of still image recording without using a self-timer will be described below.

If the self-timer setting is OFF in step S202, the flow advances to step S211 to determine if a release operation is executed. If NO in step S211, the flow advances to step S217 to terminate the process. If YES in step S211, the flow advances to step S212 to perform still image recording.

The flow advances to step S213 to hold a still image review display. The flow advances to step S214 to monitor if a normal still image review holding time has elapsed. If a predetermined time has elapsed in step S214, the flow advances to step S215 to cancel the still image review display.

The flow then advances to step S216 to display a still image preview and advances to step S217 to terminate the process.

The operation of the conventional system controller 14 is described above. According to this conventional example, in a release operation with the self-timer ON, a recorded still image is displayed for a still image review display holding time corresponding to the self-timer after recording. In a release operation with the self-timer OFF, a recorded still image is displayed for a normal still image display holding time after recording. Therefore, a still image review can be displayed for a time corresponding to the self-timer. However, after the time corresponding to the self-timer has elapsed, in order to check a still image, a still image playback mode needs to be set to check the recorded still image.

FIG. 5 is a flowchart showing the operation of the conventional system controller 14 when the remote controller is used.

The flow starts from step S300 and advances to step S301 to determine if the still image recording mode is set. If NO in step S301, the flow advances to step S309 to terminate the process.

If YES in step S301, the flow advances to step S302 to determine if a release operation by the remote controller is executed. If NO in step S302, the flow advances to step S303 to determine if a release operation of a main body is executed. If NO in step S303, the flow advances to step S309 to terminate the process. If YES in step S303, the flow advances to step S304 to perform still image recording.

If YES in step S302, the flow advances to step S304 to perform still image recording. The flow then advances to step S305 to hold a still image review display. The flow advances to step S306 to monitor if a normal still image review holding time has elapsed. If a predetermined time has elapsed, the flow advances to step S307 to cancel the still image review display. The flow advances to step S308 to display a still image preview image and advances to step S309 to terminate the process.

The operation of the conventional system controller 14 is described above. In the conventional example using the self-timer shown in FIG. 4, the still image review display holding time is changed in correspondence with the release delay time of the self-timer. However, since the still image review is canceled after the still image review display holding time has elapsed, the still image playback mode needs to be set by an operation of a main body key or the like to check the recorded still image.

In the conventional example using the remote controller shown in FIG. 4, the operation is the same as a release operation using the main body key. Since a recorded still image is displayed for a still image display holding time for normal recording, the still image playback mode needs to be set to check the recorded still image after still image recording using the remote controller.

Upon recording using a self-timer or remote controller, a photographer is often away from the camera and a still image review display is sometimes canceled while the photographer is moving to the setting location of the camera after recording. In this case, in order to check the recorded image, the photographer needs to operate the camera to set the still image playback mode to display the still image again.

Particularly, when recording using a self-timer is continuously performed with checking still images, recording and playback need to be repeated. In this manner, it is cumbersome for a photographer to check images immediately after recording.

According to Japanese Patent Publication No. 03501035, a technique of changing the display time of a recorded still image after still image recording in correspondence with a delay time by a self-timer is also available. However, generally, in still image recording using a self-timer, a photographer who activated the self-timer hurries to the object side immediately after the self-timer activation, but he or she does not always check a still image on a digital camera main body immediately after recording. For this reason, even if the display time of a still image is changed, in order to check the still image after the display time has elapsed, it is necessary to switch to the still image playback mode to check the still image.

This is the same in the case of still image recording using a remote controller. When a still image is recorded by operating a remote controller to take, e.g., a group photo, it is necessary to switch to the still image playback mode to check the recorded still image.

### SUMMARY OF THE INVENTION

The present invention has been made in consideration of the above problems, and has as its object to improve the convenience of a still image check operation after recording when a still image is recorded by using a self-timer or remote controller.

In order to solve the above problems and achieve the object, according to the first aspect of the present invention, an image capturing apparatus capable of recording a still image by using a self-timer comprises an image capturing device configured to capture an image of an object, a display unit configured to display a still image captured by the image capturing device, an operation member configured to operate the image capturing apparatus, a control unit configured to control the display unit to display a recorded still image on the display unit after still image recording using a self-timer is performed, and to continue to display the recorded still image on the display unit until the operation member is operated.

According to the second aspect of the present invention, an image capturing apparatus capable of recording a still image by an operation using a remote controller comprises an image capturing device configured to capture an image of an object, a display unit configured to display a still image captured by the image capturing device, an operation member configured to operate the image capturing apparatus, a control unit configured to control the display unit to display a recorded still image on the display unit after still image recording by remote control is performed, and to continue to display the recorded still image on the display unit until the remote controller or the operation member is operated.

According to the third aspect of the present invention, a method of controlling an image capturing apparatus capable of recording a still image by using a self-timer and comprising an image capturing device configured to capture an image of an object, a display unit configured to display a still image captured by the image capturing device, and an operation member configured to operate the image capturing apparatus, comprises a display start step of displaying a recorded still image on the display unit after still image recording using a self-timer is performed, and a display continuation step of continuing a display of the recorded still image on the display unit until the operation member is operated.

According to the fourth aspect of the present invention, a method of controlling an image capturing apparatus capable of recording a still image by an operation using a remote controller and comprising an image capturing device configured to capture an image of an object, a display unit configured to display a still image captured by the image capturing device, and an operation member configured to operate the image capturing apparatus, comprises a display start step of displaying a recorded still image on the display unit after still image recording by remote control is performed, and a display continuation step of continuing a display of the recorded still image on the display unit until the remote controller or the operation member is operated.

According to the fifth aspect of the present invention, a program causes a computer to execute the control method described above.

According to the sixth aspect of the present invention, a storage medium computer-readably stores the program described above.

Other objects and advantages besides those discussed above shall be apparent to those skilled in the art from the description of a preferred embodiment of the invention which follows. In the description, reference is made to accompanying drawings, which form a part hereof, and which illustrate an example of the invention. Such example, however, is not exhaustive of the various embodiments of the invention, and therefore reference is made to the claims which follow the description for determining the scope of the invention.

### BRIEF DESCRIPTION OF THE DRAWINGS

FIG. 1 is a block diagram showing the arrangement of a digital video camera;

FIGS. 2A and 2B are flowcharts showing the operation of a system controller upon recording using a self-timer according to an embodiment of the present invention;

FIGS. 3A and 3B are flowcharts showing the operation of the system controller upon recording using a remote controller according to an embodiment of the present invention;

FIG. 4 is a flowchart showing the operation of a conventional system controller upon recording using a self-timer; and

FIG. 5 is a flowchart showing the operation of the conventional system controller upon recording using a remote controller.

### DETAILED DESCRIPTION OF THE PREFERRED EMBODIMENT

A preferred embodiment of the present invention will now be described in detail with reference to the accompanying drawings.

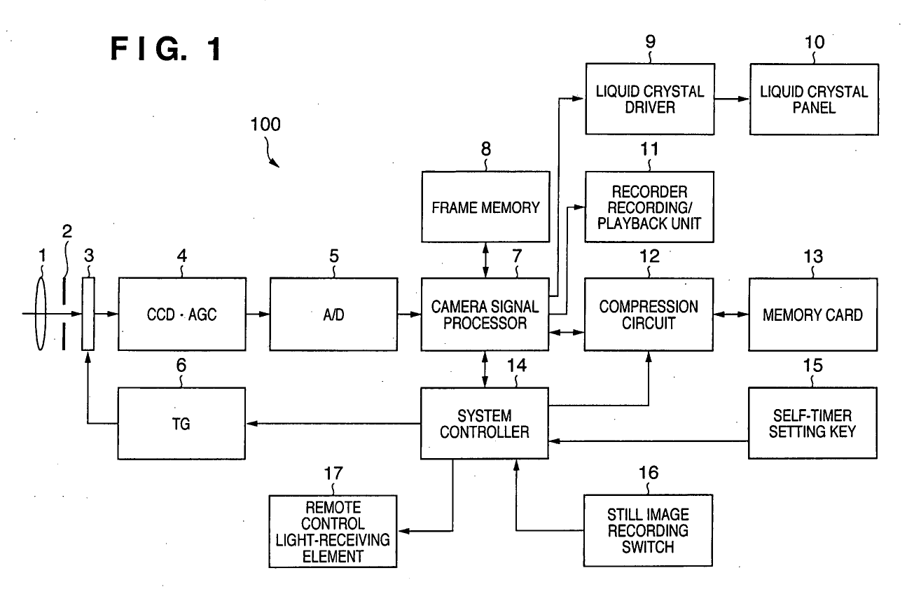

The arrangement of an image capturing apparatus according to this embodiment is the same as that of the conventional image capturing apparatus shown in FIG. 1, and a description thereof will be omitted. In this embodiment, an operation (mainly, a control operation of a system controller 14) is different from that of the conventional image capturing apparatus shown in FIG. 1.

The arrangement of a digital video camera which can photograph a still image is shown in FIG. 1. However, the present invention can be applied not only to a digital video camera but also to an image capturing apparatus such as a digital camera in the same manner as long as the apparatus can photograph a still image.

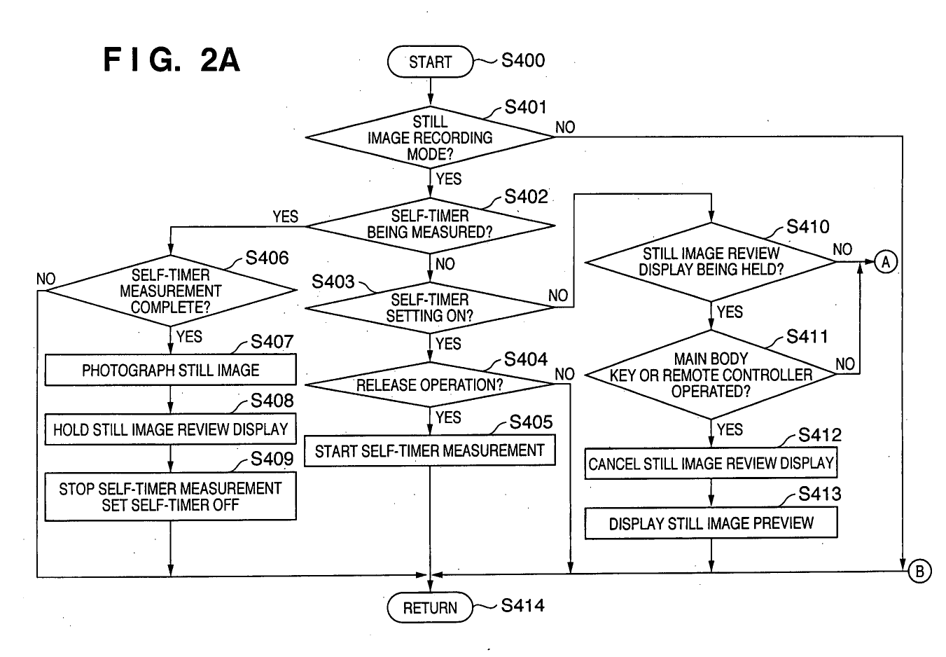

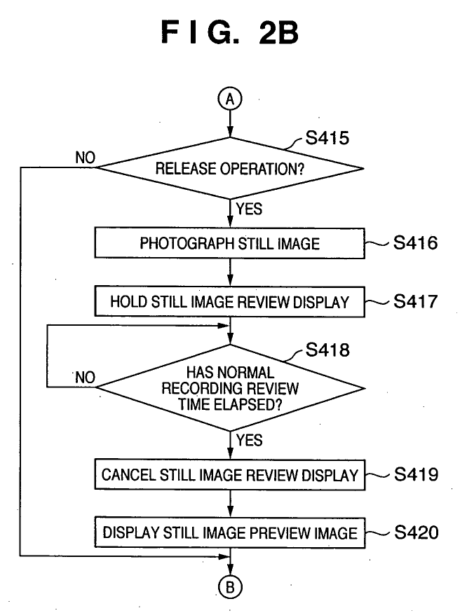

An operation of the system controller 14 in this embodiment will be described below. FIGS. 2A and 2B are flowcharts showing the sequence of still image recording using a self-timer.

The system controller 14 starts a process from step S400 at power-on. While a digital video camera 100 is on, processing from step S400 to step S414 is periodically repeated.

The flow is started in step S400 and advances to step S401 to determine if a still image recording mode is set. If NO in step S401, the flow advances to step S414 to terminate the process.

If YES in step S401, the flow advances to step S402 to determine if a recording delay time of the self-timer is being measured. If YES in step S402, the flow advances to step S406 to determine if the self-timer measurement is complete. If NO in step S402, the flow advances to step S403 to determine if the self-timer setting is ON.

If NO in step S403, the flow advances to step S410 to determine if a still image review display is being held.

If YES in step S403, the flow advances to step S404 to determine if a release operation is executed. If YES in step S404, the flow advances to step S405 to start a self-timer measurement. If NO in step S404, the flow advances to step S414 to terminate the process.

A case in which the flow branches from step S402 to step S406 will now be described.

In step S406, it is determined if the recording delay time measurement of the self-timer is complete. If No in step S406, the flow advances to step S414 to terminate the process.

If YES in step S406, the flow advances to step S407 to perform still image recording. The flow then advances to step S408 to display a still image review (operation to automatically display a recorded still image immediately after recording) and hold the display. The still image review may be displayed in step S408 after an elapse of a predetermined time from a time point of a completion of still image recording in step S407. In this case, a predetermined time to wait for a review display is desirably set variable in accordance with a recording delay time of the self-timer. With this arrangement, the review is not displayed while a photographer is returning to the setting location of the digital video camera 100.

The flow advances to step S409 to stop the measurement of the self-timer and turn off the self-timer setting and then advances to step S414 to terminate the process.

Next, a case in which the flow branches from step S403 to step S410 will be described.

In step S410, it is determined if a still image review display is being held. If NO in step S410, the flow advances to step S415.

If YES in step S410, i.e., if still image recording using the self-timer has been performed, the flow advances to step S411 to determine if a main body key (any one of operation keys mounted on the digital video camera 100 except a still image recording switch (release switch) 16) or remote controller is operated. If NO in step S411, the flow advances to step S415.

If YES in step S411, the flow advances to step S412 to cancel the still image review display. The flow then advances to step S413 to display a still image preview (operation to display the angle of view for still image recording in motion upon still image recording) and return to a normal still image recording standby state. The flow advances to step S414 to terminate the process.

In step S415, it is determined if a release operation is executed. If NO in step S415, the flow advances to step S414 to terminate the process. If YES in step S415, the flow advances to step S416 to perform still image recording.

Next, the flow advances to step S417 to hold a still image review display. The flow advances to step S418 to monitor if a normal still image review holding time has elapsed. If a predetermined time has elapsed in step S418, the flow advances to step S419 to cancel the still image review display.

The flow advances to step S420 to display a still image preview and then advances to step S414 to terminate the process.

In the operation of still image recording using the self-timer shown in FIGS. 2A and 2B, a predetermined recording delay time of the self-timer is measured after a release operation and still image recording is performed after the measurement. After that, a still image review is displayed in the same manner as in normal recording. However, the display keeps holding the still image review without returning to a still image preview. The still image review display is held until the main body key or remote controller is operated next. When the main body key or remote controller is operated, the still image review display is canceled to switch to a still image preview display.

Note that a method of keeping holding a still image review display may be a method of controlling not to update image data output from a signal processing circuit 7 to a liquid crystal driver 9 or a method of temporarily freezing the operation of the liquid crystal driver 9.

In this manner, even if it takes time for a photographer to return to the setting location of the digital video camera 100 after recording using the self-timer, a recorded still image remains displayed on a liquid crystal panel 10. This makes it easy to check the recorded image. That is, it is unnecessary to switch to the still image playback mode in order to check the still image, therefore the operability of still image recording using the self-timer significantly improves.

Note that when not the main body key or remote controller but the still image recording switch (release switch) 16 is operated after recording using the self-timer or when the still image recording switch (release switch) 16 is normally operated without performing recording using the self-timer, normal still image recording is performed. In this case, since a photographer is near the digital video camera 100, it is unnecessary to keep holding a still image review display in the same manner as in the case of recording using the self-timer. Therefore, a still image review display time is set as the same as in normal recording.

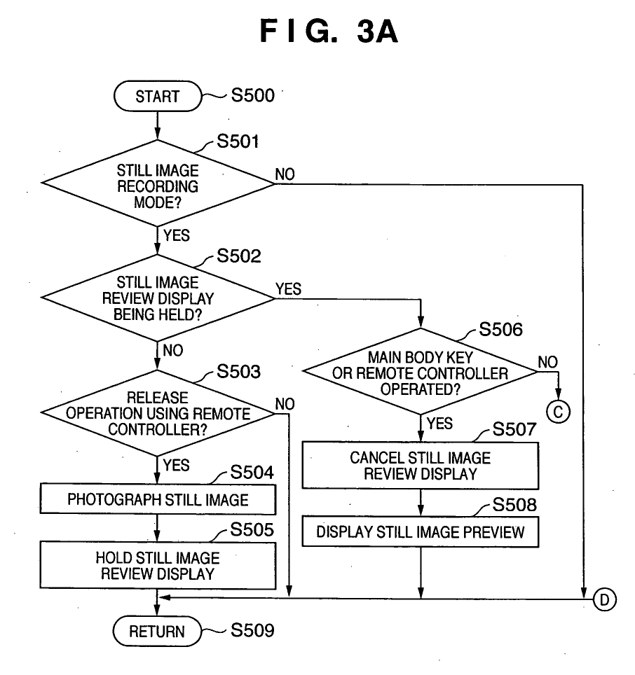

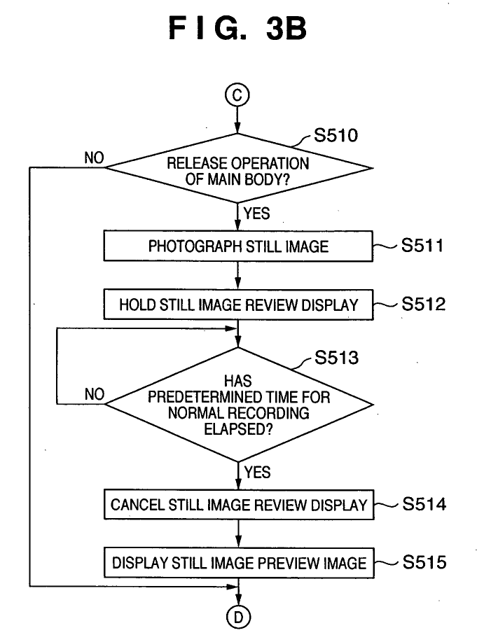

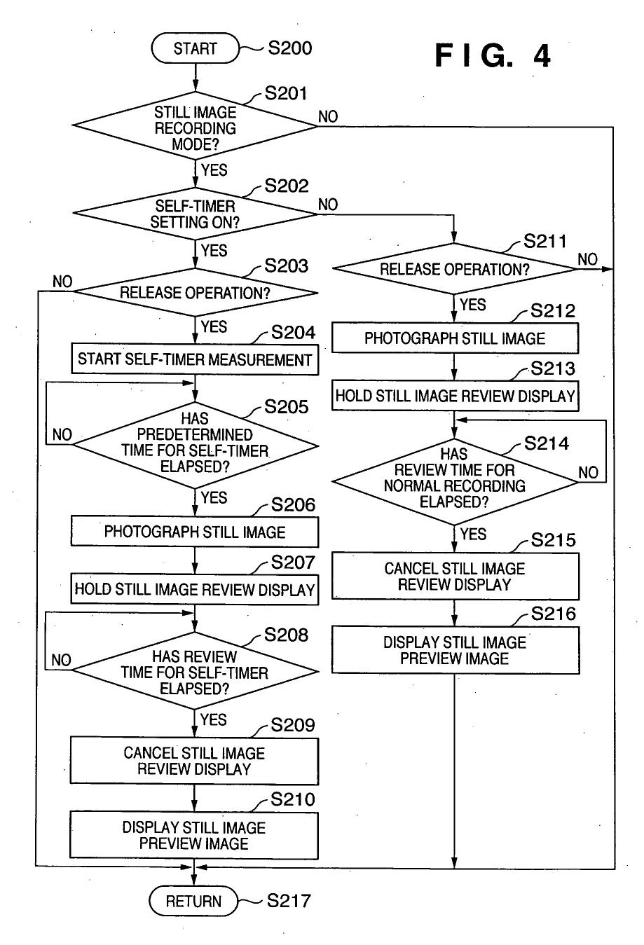

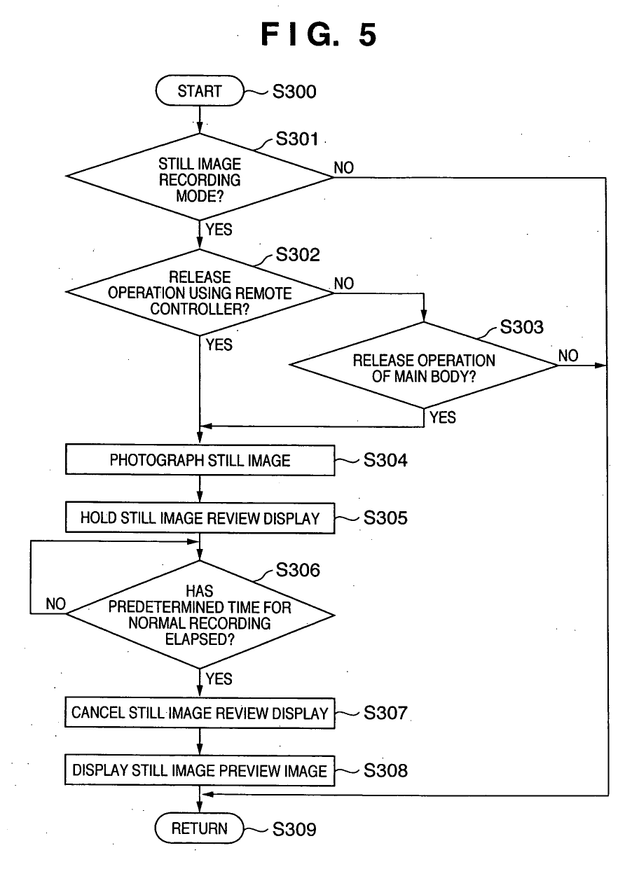

FIGS. 3A and 3B are flowcharts showing the sequence when still image recording is performed by using a remote controller.

The system controller 14 starts a process from step S500 at power-on. While a digital video camera 100 is on, processing from step S500 to step S509 is periodically repeated.

The flow is started in step S500 and advances to step S501 to determine if the still image recording mode is set. If NO in step S501, the flow advances to step S509 to terminate the process.

If YES in step S501, the flow advances to step S502 to determine if a still image review display is being held.

If YES in step S502, the flow advances to step 506 to determine if an operation using the main body key or remote controller is performed.

If NO in step S502, the flow advances to step S503 to determine if a release operation by a remote controller is executed.

If NO in step S503, the flow advances to step S509 to terminate the process. If YES in step S503, the flow advances to step S504 to perform still image recording.

Then the flow advances to step S505 to hold a still image review display and advances to step S509 to terminate the process. Note that the still image review may be displayed in step S505 after an elapse of a predetermined time from the time point of a completion of still image recording in step S504. With this arrangement, the review is not displayed while a photographer is returning to the setting location of the digital video camera 100.

If it is determined that the still image review display is being held in step S502, the flow advances to step S506 to determine if the main body key (any one of operation keys mounted on the digital video camera 100 except the still image recording switch (release switch) 16) or remote controller is operated. If NO in step S506, the flow advances to step S510. If YES in step S506, the flow advances to step S507 to cancel the still image review display, advances to step S508 to display a still image preview, and advances to step S509 to terminate the process.

In step S510, it is determined if a release operation (operation of the still image recording switch (release switch) 16) of the main body is executed. If NO in step S510, the flow advances to step S509 to terminate the process. If YES in step S510, the flow advances to step S511 to perform still image recording.

Next, the flow advances to step S512 to hold a still image review display. The flow advances to step S513 to monitor if a normal still image review holding time has elapsed. If a predetermined time has elapsed, the flow advances to step S514 to cancel the still image review display. The flow advances to step S515 to display a still image preview image and advances to step S509 to terminate the process.

In the operation of still image recording using the remote controller shown in FIGS. 3A and 3B, a still image is recorded after a release operation and a still image review is displayed in the same manner as in normal recording. However, after that, the display keeps holding the still image review without returning to a still image preview. The still image review display is held until the main body key or remote controller is operated next. When the main body key or remote controller is operated, the still image review display is canceled to switch to a still image preview display.

Note that a method of keeping holding a still image review display may be a method of controlling not to update image data output from the signal processing circuit 7 to the liquid crystal driver 9 or a method of temporarily freezing the operation of the liquid crystal driver 9.

In this manner, even if it takes time for a photographer to return to the setting location of the digital video camera 100 after recording using the remote controller, a recorded still image remains displayed on the liquid crystal panel 10. This makes it easy to check the recorded image. That is, it is unnecessary to switch to the still image playback mode in order to check the still image, therefore the operability of still image recording using the remote controller significantly improves.

Note that when not the main body key or remote controller but the still image recording switch (release switch) 16 is operated after recording using the remote controller or when the still image recording switch (release switch) 16 is normally operated without performing recording using the remote controller, normal still image recording is performed. In this case, since a photographer is near the digital video camera 100, it is unnecessary to keep holding a still image review display in the same manner as in the case of recording using the self-timer. Therefore, a still image review display time is set as the same in normal recording.

As has been described above, according to the above embodiment, in still image recording using a remote controller or self-timer, since a still image review display is held after still image recording until the next operation of main body key or remote controller, a recorded still image can be checked without any operation. Therefore, the operability of still image recording using a remote controller or self-timer can be significantly improved.

### Other Embodiment

The object of each embodiment is achieved by supplying a storage medium (or recording medium) recording software program codes for implementing the functions of the above-described embodiment to a system or apparatus, and causing the computer (or a CPU or MPU) of the system or the apparatus to read out and execute the program codes stored in the storage medium. In this case, the program codes read out from the storage medium implement the functions of the above-described embodiment by themselves, and the storage medium storing the program codes constitutes the present invention. The functions of the above-described embodiment are implemented not only when the readout program codes are executed by the computer but also when the Operating System (OS) or the like running on the computer performs part or all of actual processing on the basis of the instructions of the program codes.

Furthermore, the functions of the above-described embodiment are also implemented when the program codes read out from the storage medium are written in the memory of a function expansion card inserted into the computer or a function expansion unit connected to the computer, and the CPU or the like of the function expansion card or function expansion unit performs part or all of actual processing on the basis of the instructions of the program codes.

When the present invention is applied to the storage medium described above, program codes corresponding to the above-described procedure are to be stored in the storage medium.

The present invention is not limited to the above embodiments and various changes and modifications can be made within the spirit and scope of the present invention. Therefore, to apprise the public of the scope of the present invention the following claims are made.

This application claims the benefit of Japanese Application No. 2005-190504, filed Jun. 29, 2005, which is hereby incorporated by reference herein in its entirety.

What is claimed is:

1. An image capturing apparatus capable of recording a still image by using a self-timer, comprising:
an image capturing device configured to capture an image of an object;
a display unit configured to display a still image captured by said image capturing device;
an operation member configured to operate the image capturing apparatus;
a control unit configured to control said display unit to display a recorded still image on said display unit after still image recording using a self-timer is performed, and to continue to display the recorded still image on said display unit until said operation member is operated.

2. The apparatus according to claim 1, wherein said control unit cancels a display of a recorded still image on said display unit after an elapse of a predetermined time when still image recording without using a self-timer is performed.

3. An image capturing apparatus capable of recording a still image by an operation using a remote controller, comprising:
an image capturing device configured to capture an image of an object;
a display unit configured to display a still image captured by said image capturing device;
an operation member configured to operate the image capturing apparatus;
a control unit configured to control said display unit to display a recorded still image on said display unit after still image recording by remote control is performed, and to continue to display the recorded still image on said display unit until the remote controller or said operation member is operated.

4. The apparatus according to claim 3, wherein said control unit cancels a display of a recorded still image on said display unit after an elapse of a predetermined time when still image recording without using a remote controller is performed.

5. A method of controlling an image capturing apparatus capable of recording a still image by using a self-timer and comprising an image capturing device configured to capture an image of an object, a display unit configured to display a still image captured by the image capturing device, and an operation member configured to operate the image capturing apparatus, comprising
a display start step of displaying a recorded still image on the display unit after still image recording using a self-timer is performed, and
a display continuation step of continuing a display of the recorded still image on the display unit until the operation member is operated.

6. The method according to claim 5, further comprising a display cancellation step of canceling a display of a recorded still image on the display unit after an elapse of a predetermined time when not still image recording without using a self-timer is performed.

7. A method of controlling an image capturing apparatus capable of recording a still image by an operation using a remote controller and comprising an image capturing device configured to capture an image of an object, a display unit configured to display a still image captured by the image capturing device, and an operation member configured to operate the image capturing apparatus, comprising
a display start step of displaying a recorded still image on the display unit after still image recording when still image recording by remote control is performed, and
a display continuation step of continuing a display of the recorded still image on the display unit until the remote controller or the operation member is operated.

8. The method according to claim 7, further comprising a display cancellation step of canceling a display of a recorded still image on the display unit after an elapse of a predetermined time when still image recording without using a remote controller is performed.

9. A program causing a computer to execute a control method according to claim 5.

10. A program causing a computer to execute a control method according to claim 7.

11. A storage medium computer-readably storing a program according to claim 9.

12. A storage medium computer-readably storing a program according to claim 10.
